(19) United States
(12) Patent Application Publication
(10) Pub. No.: US 2009/0130263 A1
(43) Pub. Date: May 21, 2009

(54) DISPOSABLE CAKE COVER

(76) Inventor: Chip Valor, Schaumburg, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 11/940,627

(22) Filed: Nov. 15, 2007

(51) Int. Cl. B65D 85/60; A23L 1/48

(52) U.S. Cl. 426/87; 426/115

(57) ABSTRACT

Aspects of the invention provide for an accessory for the baling industry to provide a more pleasant experience to its customers for a celebratory event. Further, aspects for the invention provide for a disposable baked good cover where the inner surface of the cover is a malleable non-stick baked good cover that allows customers to transport baked goods without harming baked good decorations such as, but not limited to, icing, frosting, cake decorations such as frosting flowers, cake writing, etc. In addition, aspects of the invention provide for a baked good cover where the outer surface is of an anti-bacterial or other anti-pollutant material that prevents for environmental and ambient pollutants to enter the baked good. Also, the outer material is flame retardant.

### BACKGROUND OF THE INVENTION

The baking industry provides baked goods for customers who are celebrating a wide range of special occasions. The baked goods may include cakes, cupcakes, pies, cookies, or any other of a variety of baked goods. The baking industry provides different cake decorations and accessories for their baked goods to provide a more pleasant experience for their customers' celebratory event.

### BRIEF SUMMARY OF THE INVENTION

Aspects of the invention provide for an accessory for the baking industry to provide a more pleasant experience to its customers for a celebratory event. Further, aspects for the invention provide for a disposable baked good cover where the inner surface of the cover is a malleable non-stick baked good cover that allows customers to transport baked goods without harming baked good decorations such as, but not limited to, icing, frosting, cake decorations such as frosting flowers, cake writing, etc. In addition, aspects of the invention provide for a baked good cover where the outer surface is of an anti-bacterial or other anti-pollutant material that prevents for environmental and ambient pollutants to enter the baked good. Also, the outer material is flame retardant.

### BRIEF DESCRIPTION OF THE SEVERAL VIEWS OF THE DRAWING(S)

FIG. 1 illustrates an exemplary environment where aspects of the invention may be used;

FIG. 2 illustrates an exemplary embodiment of the invention;

FIG. 3 illustrates another exemplary embodiment of the invention;

FIG. 4 illustrates an embodiment of the invention used within an exemplary environment.

### DETAILED DESCRIPTION OF THE INVENTION

Aspects of the invention provide for an accessory for the baking industry to provide a more pleasant experience to its customers for a celebratory event. Further, aspects for the invention provide for a disposable baked good cover where the inner surface of the cover is a malleable non-stick baked good cover that allows customers to transport baked goods without harming baked good decorations such as, but not limited to, icing, frosting, cake decorations such as frosting flowers, cake writing, etc. In addition, aspects of the invention provide for a baked good cover where the outer surface is of an anti-bacterial or other anti-pollutant material that prevents for environmental and ambient pollutants to enter the baked good. Also, the outer material is flame retardant.

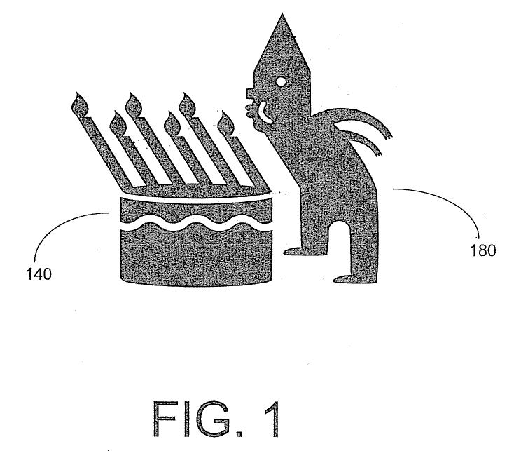

FIG. 1 illustrates an exemplary environment where aspects of the invention may be used. For example, a baked good such as a birthday cake may be decorated with icing, frosting, cake decorations such as flowers or other designs, writing, and candles. Transporting cakes in traditional containers may harm or damage these baked good decorations and accessories. Further, when a customer presents a baked good or cake at a celebratory event, it may be exposed to environmental and ambient pollutants. In addition, a cake or baked good 140 may be exposed to pollutants when its candles are blown out by a celebrant 180. Aspects of the invention prevent damage or harm to baked good decorations and accessories during transport of a baked good. Further, aspects of the invention prevent baked good exposure to harmful pollutants until the baked good is served to individuals.

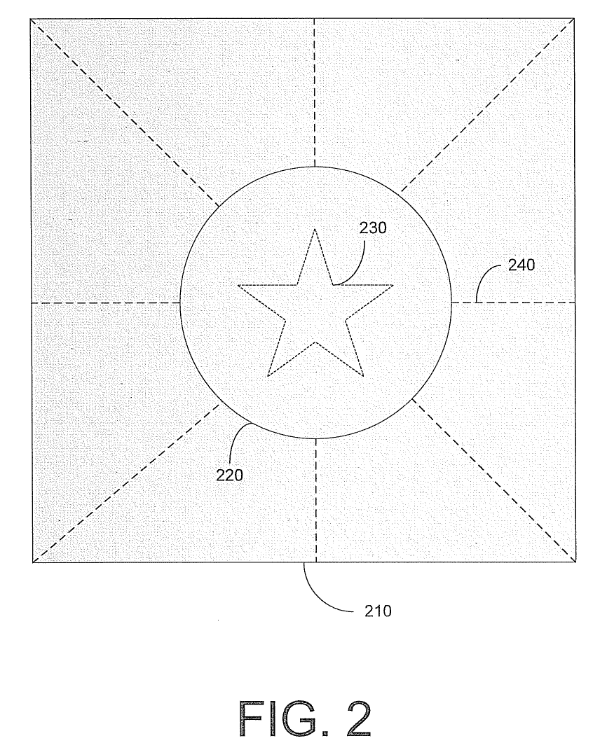

Aspects of the invention may be called a disposable baked good or cake cover. Note that whenever a cake or other specific baked good is mentioned, the description also pertain to any other baked good such as, but not limited to, cakes, cupcakes, pies, cookies, or any other of a variety of baked goods. FIG. 2 illustrates an exemplary embodiment of the invention. An embodiment of a disposable cake cover is shown 210. Embodiments of a disposable cake cover may be made of cellophane, saran polyvinylidene chloride (also called PVDC), or any other similar flexible material. An embodiment of a disposable cake cover may be used in conjunction with any size or shape cake. The embodiment shown in FIG. 2 is for a round cake 220. Embodiments of a disposable cake cover may also contain a design that matches the cake design or provides a new cake design for the customer. The customer may use the design on the embodiment disposable cake cover to place candles on the cake. For example, in FIG. 2 the design on the cake cover is a star 230. A customer may place candles on the cake at the vertex of the star shape. Further, embodiments of a disposable cake cover may place markings (such as an X) to indicate a preferred placement of candles to the customer. In addition, embodiments of disposable cake cover may contain pleats 240 that provide a guide for a customer to fold the embodiment disposable cake cover around the cake for easier use.

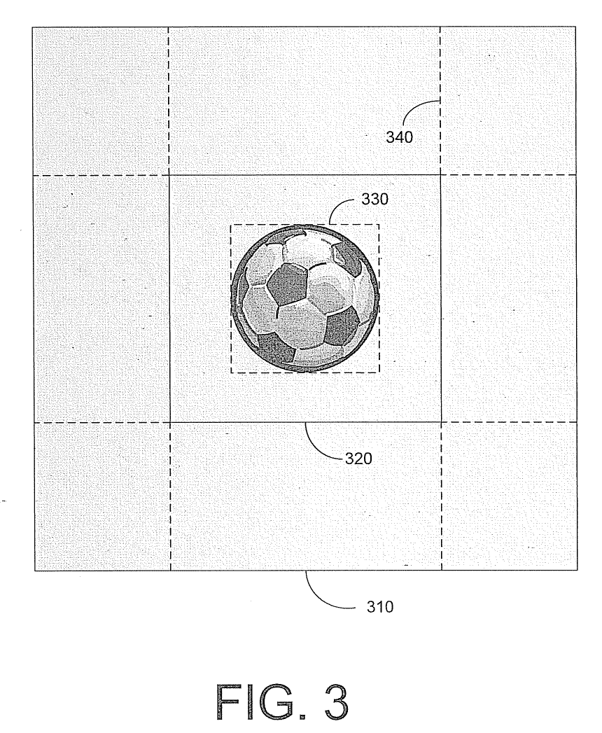

Aspects of the invention may also be for any size or shape baked good such as a sheet cake, pie, layered cake, tiered cake, muffin, cookie, etc. FIG. 3 illustrates another exemplary embodiment of the invention where the exemplary disposable cake cover 310 is for a rectangular sheet cake 320. The design on the exemplary disposable cake cover is a soccer ball 330. A customer may design her own cake decorations according to the design or place candles on the design to ease customer use of the baked good in the celebratory event. The exemplary method provides pleats 340 as a guide for a customer to fold the embodiment disposable cake cover around the cake for easier use, similar in function as the pleats 240 shown in FIG. 2.

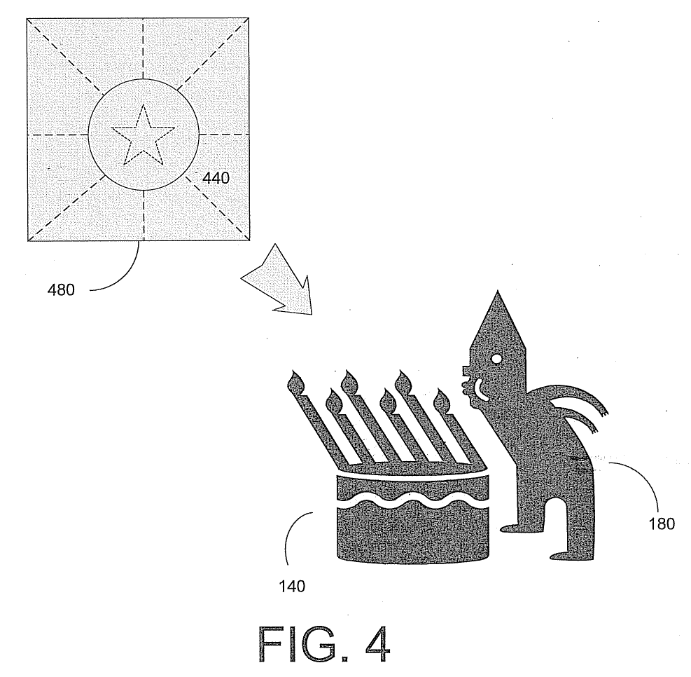

FIG. 4 illustrates an embodiment of the invention used within an exemplary environment. An exemplary embodiment disposable cake cover as shown in FIG. 2 is placed on a cake 140. The exemplary disposable cake cover is folder over the cake along the pleats 240. The inner surface 480 of the exemplary disposable cake cover, or the side that is in contact with the baked good, has a malleable non-stick surface that prevents and harm or damage to the baked good or its decorations, icing, frosting, writing, etc. The outer surface of the exemplary disposable cake cover contains an anti-bacterial, anti-pollutant material such that it prevents environmental or ambient pollutants 180 to adhere to the cake 140. Also, the outer material is flame retardant.

Accordingly, an apparatus for a baked good cover has been disclosed. Those skilled in the art will appreciate that variations to the above disclosure may be employed without departing from the spirit and scope of the teachings herein. The scope of protection, therefore, should not be limited to the above currently preferred embodiments. Instead, the invention is intended to extend to the appended claimed subject matter, which is also made part of this disclosure.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An apparatus for a disposable baked good cover, comprising
a flexible, malleable material wherein;
an inner surface of the flexible, malleable material is non-stick such that it does not adhere to the surface of a baked good when it is in contact of the baked good;
an outer surface of the flexible, malleable material is of an anti-bacterial and anti-pollutant material such that it prevents anti-bacterial and anti-pollutant sources in the environment to adhere to the baked good;
an outer surface of the flexible, malleable material is of a flame retardant material;
a plurality of pleats to guide customer use in folding the disposable baked good cover around and in contact with the baked good.

2. An apparatus according to claim 1, wherein the flexible, malleable material may be imprinted with a design for the customer to copy onto a baked good, or to place candles on top of the baked good.

3. An apparatus according to claim 3; wherein the design on the disposable baked good cover may be imprinted with indications to place candles for a preferred design of candles on top of the baked good.

4. An apparatus according to claim 1, wherein the disposable baked good cover has a design and shape applicable to any shape or size baked good.

5. An apparatus according to claim 1, wherein the baked good is selected from a group consisting of a cake, pie, cupcakes, cookie, doughnut, muffin, or ice cream cake.
